(19) United States
(12) Patent Application Publication
(10) Pub. No.: US 2016/0196089 A1
(43) Pub. Date: Jul. 7, 2016

(54) SYSTEM AND METHOD FOR ADAPTIVE DATA TRANSFERS WITH LIMITED RESOURCES

(71) Applicant: NetApp, Inc., Sunnyvale, CA (US)

(72) Inventors: Vijay Vinayak Gadre, Bangalore (IN); Vijaya Bhaskar Reddy CH, Bangalore (IN); Vitaly Revsin, Andover, MA (US)

(21) Appl. No.: 14/591,557

(22) Filed: Jan. 7, 2015

(51) Int. Cl. G06F 3/06

(52) U.S. Cl. CPC G06F 3/0647; G06F 3/0689; G06F 3/0619; G06F 3/0665; G06F 3/0685

(57) ABSTRACT

A method and system for adaptive data transfers with limited resources are described. A data storage system performs operations that include migrating data from one set of storage volumes to another set of storage volumes using a number of data streams managed by a storage controller. During this data migration process, the storage controller can measure performance of the data storage system such as the CPU load, memory usage, network bandwidth usage, and the total number of data streams in use. Based on the measured performance and scheduling information, the data storage system can adjust the number of concurrent data streams dedicated to data migration in order to complete the migration process in a timely fashion without substantial undue impact to client accesses and backup operations.

### TECHNICAL FIELD

Examples described herein relate to data storage systems, and more specifically, to a method and system for adaptive data transfers with limited resources.

### BACKGROUND

Data migration is the process of transferring data between storage types, formats, or computer systems. It is a key consideration for any system implementation, upgrade, or consolidation. Data migration is usually performed programmatically to achieve an automated migration, freeing up human resources from tedious tasks. Data migration occurs for a variety of reasons, including: server or storage equipment replacements or upgrades, website consolidation, server maintenance, and data center relocation.

To achieve an effective data migration procedure, data on the old system is mapped to the new system providing a design for data extraction and data loading. The design relates old data formats to the new system's formats and requirements. Programmatic data migration may involve many phases, but it minimally includes data extraction where data is read from the old system and data loading where data is written to the new system.

Disaster recovery involves a set of policies and procedures to enable the recovery or continuation of vital technology infrastructure and systems following a natural or human-induced disaster. Disaster recovery focuses on the IT or technology systems supporting critical business functions, which includes important data saved on physical media. In order to implement effective disaster recovery, data is regularly backed up from primary servers to secondary backup servers. In the event of disaster or other data loss from the primary server, backed up data on the secondary server can be used to restore the lost data and resume normal operations.

### BRIEF DESCRIPTION OF THE DRAWINGS

FIG. 1 illustrates an example system for adaptive data transfers with limited resources, in accordance with some aspects.

FIG. 2 illustrates an example source controller operable for managing data transfers and implementing adaptive data transfers with limited resources, in accordance with some aspects.

FIG. 3 illustrates an example method of adaptive data transfers with limited resources, in accordance with some aspects.

FIG. 4 is a block diagram that illustrates a computer system upon which examples described herein may be implemented.

### DETAILED DESCRIPTION

Examples described herein include a computer system to manage a number of data streams, during a data migration process, based on stream priority, system resources, and scheduling information in order to complete the data migration process efficiently without substantial undue impact to critical operations.

In an aspect, a data storage system 100 performs operations that include migrating data from one set of storage volumes to another set of storage volumes using a number of data streams managed by a storage controller. During this data migration process, the storage controller can measure performance of the data storage system such as the CPU load, memory usage, network bandwidth usage, and the total number of data streams in use. Based on the measured performance, the data storage system can adjust the number of concurrent data streams dedicated to data migration.

In some aspects, a number of concurrent data streams dedicated to data migration can be temporarily paused when the measured performance is below a programmed threshold. When the measured performance is above a programmed threshold, the number of concurrent data streams dedicated to data migration can instead be increased. These thresholds can be preset for each storage controller or set by individuals such as a data center administrator or user.

In one aspect, the set of volumes holding the data to be migrated is associated with one storage architecture, and the data storage system migrates the data to a new set of volumes associated with a different storage architecture.

In an aspect, the data streams dedicated to the data migration process are deemed less critical than other types of streams, such as operations backing up data from the set of volumes to a secondary system. In the case that the backup operation has a set schedule, the data storage system can reduce or pause the number of concurrent data streams used for migration during the times corresponding to the backup schedule.

By utilizing adaptive data transfers in a limited resource environment, a migration operation can be performed efficiently while limiting the impact of the migration on more critical operations such as data backups and client requests. This can allow the data storage system to complete the migration in a timely fashion while at the same time avoiding overloading it, which can be important since data is often migrated off storage systems near their end of life.

One or more examples described herein provide that methods, techniques and actions performed by a computing device are performed programmatically, or as a computer-implemented method. Programmatically means through the use of code, or computer-executable instructions. A programmatically performed step may or may not be automatic.

One or more examples described herein may be implemented using programmatic modules or components. A programmatic module or component may include a program, a subroutine, a portion of a program, a software component, or a hardware component capable of performing one or more stated tasks or functions. In addition, a module or component can exist on a hardware component independently of other modules or components. Alternatively, a module or component can be a shared element or process of other modules, programs or machines.

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing some embodiments can be carried and/or executed. In particular, the numerous machines shown in some examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs.

### SYSTEM OVERVIEW

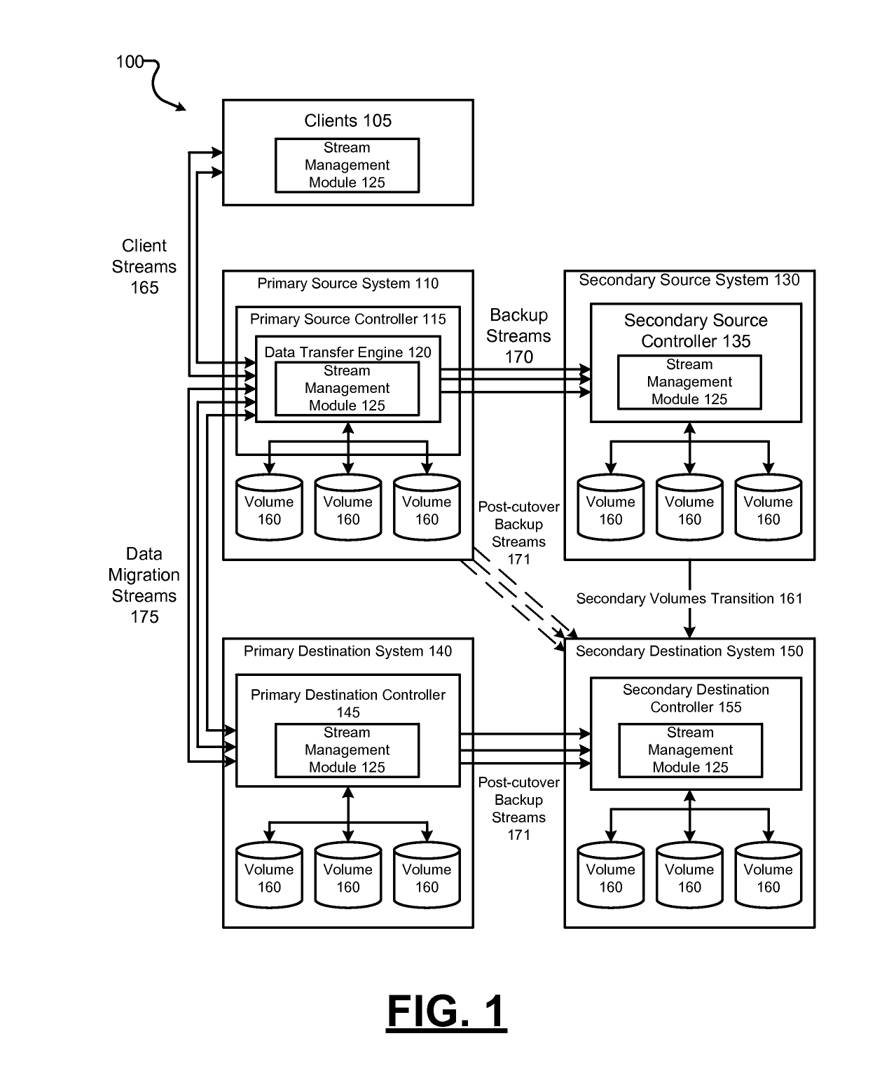

FIG. 1 illustrates a data storage system 100, within which adaptive data transfers with limited resources may be provided. The data storage system 100 includes clients 105 that can access a primary source system 110 in order to perform operations such as migrating data from the primary source system 110 to a primary destination system 140. The primary source system 110 houses a primary source controller 115 which can provide an operating system controlling primary source system 110. In some aspects, primary source system 110 can contain more than one primary source controller 115. Data transfer engine 120 and its stream management module 125 can run on the primary source controller 115 in order to manage aspects of data transfers such as migration of data, backing up data, and general input/output requests from, for example, clients 105. In some aspects, clients 105 and all controllers 115, 135, 145, 155 can include a stream management module 125. The secondary source system 130, managed by secondary source controller 135, can act as a data backup destination for primary source system 110 for use in disaster recovery in the event of data loss on the primary source system 110. Similar to the backup process used in the two source systems, the primary destination controller 145 can back up its data by communicating with the secondary destination controller 155 of secondary destination system 150. Additionally, after the secondary volumes 160 are transitioned from secondary source system 130 to secondary destination system 150 but before volumes 160 have been migrated to the primary destination system 140, primary source controller 115 can use post-cutover backup streams 171 to back up data to the secondary destination system 150.

In one aspect, primary source system 110 and secondary source system 130 are configured in a data storage architecture different from the data storage architecture of primary destination system 140 and secondary destination system 150, and the data transfer engine 120 is configured to transition the data stored on volumes 160 from the source architecture to the destination architecture. For example, the primary source system 110 and secondary source system 130 can run on a 7-Mode architecture designed by NetApp, Inc. and the primary destination system 140 and secondary destination system 150 can run on a clustered-mode architecture also designed by NetApp, Inc. However, the method described for adaptive data transfers with limited resources can be applied to a migration between any architecture or between systems running the same architecture.

In an adaptive data transfer system, stream management module 125 monitors performance metrics of limited resources such as CPU load, memory usage, and bandwidth usage along with backup schedules in order to balance client streams 165, backup streams 170, 171 and data migration streams 175 so that the data on volumes 160 is migrated with minimal impact on more critical backup and client operations. In some aspects, stream management module 125 is part of data transfer engine 120 and runs on controllers, such as the primary source controller 115. In other aspects, stream management module 125 can run on an external host (not pictured). In addition, client streams 165 can represent client accesses to the primary source system 110. In some aspects, clients 105 may access data in the data storage system 100 through other channels not pictured here.

In one aspect, each of the backup streams 170 and data migration streams 175 correspond to one of the volumes 160. For example, if there are 20 volumes 160 on the primary source system 110 that are being migrated, there may be up to 20 data migration streams 175. However, if primary source controller 115 does not have adequate resources to maintain 20 data migration streams 175, as many volumes as possible can be migrated simultaneously with a new volume beginning the migration process as soon as a previous one is finished.

In this context, a volume is a single accessible storage area with a single file system accessed with an operating system's logical interface. In one aspect, volumes 160 are stored in their entirety on a single physical disk. In other aspects, volumes 160 are distributed across multiple disks and may be accessed by more than one storage system. Disks can be grouped into Redundant Array of Inexpensive Disks (RAID) groups, and multiple RAID groups can form an aggregate on which the primary source controller 115 can set up volumes 160.

Data replication over backup streams 170, 171 can operate at the physical block level on volumes 160. Data transfer engine 120 can replicate the contents of an entire volume 160, including all snapshot copies, plus all volume attributes verbatim from a source (primary) volume 160 to a target (secondary) volume 160. If other features such as deduplication or data compression are running on the primary system, the destination volume 160 inherits those savings since the volume 160 that is replicated is identical.

In some aspects, volume 160 replication begins with a baseline copy in which all data in the volume 160 is replicated from source to target. Once the baseline is completed, replication occurs on a regular basis. Should it be necessary, the target can be made writable. In other words, if a failure occurs that affects the source or primary systems, operations directed to the source or primary systems can fail over and start writing to the target. Once the failure has been corrected, a failback resynchronization can be performed to copy data changes back to the source and restore normal operation.

In some aspects, backup volumes 160 on secondary source system 130 are transitioned to the secondary destination system 150 as part of the migration process. A secondary volumes transition 161 relationship is created, and data from the volumes 160 on secondary source system 130 are replicated as described above to the secondary destination system 150. Once the data has been replicated, the secondary volumes transition 161 relationship is broken. During a cutover phase, a backup relationship can then be established between primary source system 110 and secondary destination system 150 such that post-cutover backup streams 171 will back up changes made to volumes 160 on the primary source system 110 to the volumes 160 on secondary destination system 150.

Once the migration process between primary source system 110 and primary destination system 140 is completed, the backup relationship between the primary source system 110 and secondary destination system 150 is broken. In addition, the migration relationship between primary source system 110 and primary destination system 140 is also broken. A new backup relationship is established between primary destination system 140 and secondary destination system 150, volumes 160 on primary source system 110 are taken offline, and Internet Protocol (IP) addresses in data storage system 100 are updated to reflect the new relationships and direct client streams 165 to primary destination system 140.

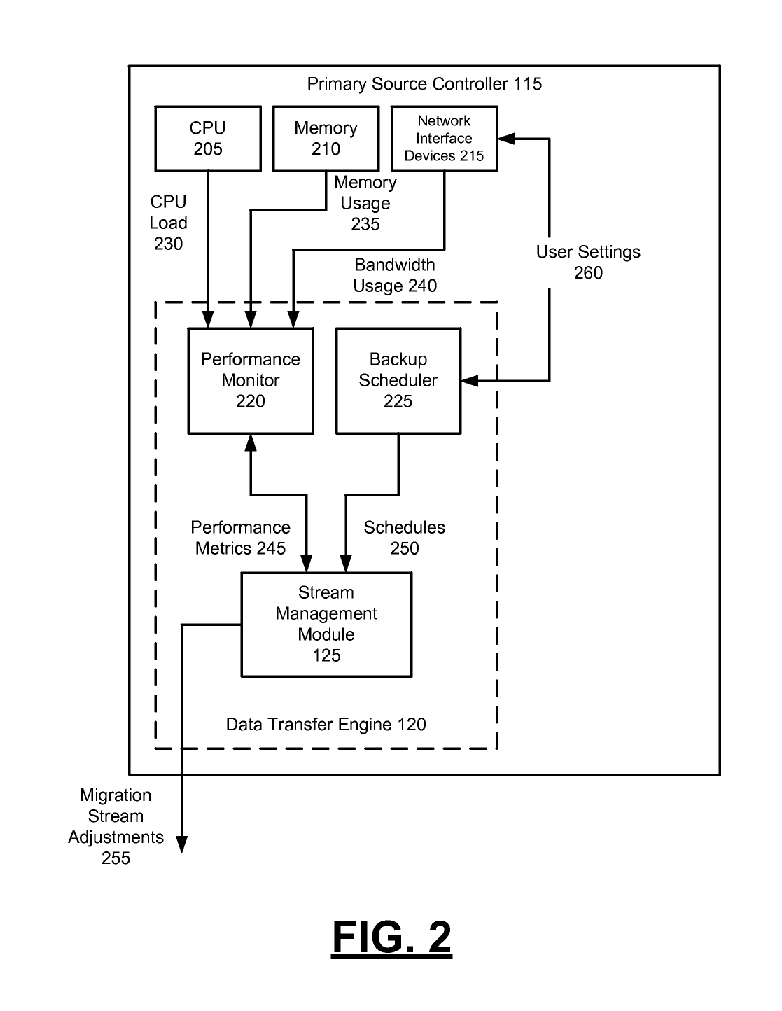

FIG. 2 illustrates an example source controller, in this case primary source controller 115 depicted in FIG. 1, operable for managing data transfers and implementing adaptive data transfers with limited resources, in accordance with some aspects. The primary source controller 115 can include more components than depicted in FIG. 2, which has been simplified to highly components that are used in adaptive data transfers with limited resources, in accordance with some aspects.

Primary source controller 115 contains a number of physical components such as a central processing unit (CPU) 205, memory 210, and one or more network interface devices 215. Among other components, these three comprise limited resources that are managed by the primary source controller 115 during data transfers.

CPU 205 may be any microprocessor containing one or more cores which carry out the instructions of computer programs by performing basic arithmetical, logical, and input/output operations for the primary source controller 115. In some examples, there may be more than one CPU 205, each capable of performing operations in parallel. CPUs can only perform a finite amount of computational work in a given time period distributed among the tasks being requested by the system. The amount of computational work done as compared to the demands placed on CPU 205 for work can be represented by CPU load 230. For example, if the primary source controller 115 is idle, CPU load 230 may be zero; if the primary source controller 115 is loaded to capacity with operations, however, the CPU load 230 may be 1.0 or 100%. Fully loaded CPUs may suffer reduced performance which can impact the amount of time needed to perform tasks on the system, such as backing up data, migrating data, and responding to client requests.

Memory 210 may be any type of computer memory, such as dynamic random-access memory (DRAM) or non-volatile random-access memory (NVRAM), which stores data and instructions for the primary source controller 115. Similar to CPU processing power, a system has a finite amount of memory in which to store data and instructions, which limits the number of concurrent processes the system can execute before having a substantial impact on performance. For example, each instance of a client stream 165, backup stream 170, and data migration stream 175 illustrated in FIG. 1 uses an amount of memory, therefore limiting the total number of streams to the maximum that memory 210 can support concurrently. In one aspect, memory usage 235 represents a fraction or percentage of memory 210 that is currently in use by the primary source controller 115.

Network interface devices 215 can be any types of controllers or adapters that connect primary source controller 115 to one or more networks, over which the various streams of FIG. 1 are transmitted. For example, network interface devices 215 can include Ethernet adapters, Wi-Fi adapters, or any other networking hardware. Each of the network interface devices 215 and their associated networks may have a limited bandwidth or throughput, which represent the amount of bits per unit of time that can be transferred from primary source controller 115 to one of many destinations. In one example, these destinations are clients 105, secondary source system 130, and primary destination system 140 illustrated in FIG. 1. The total amount of bandwidth currently being used as compared to the maximum bandwidth available to the system can be represented by bandwidth usage 240. In one aspect, the bandwidth available to different operations can be restricted by user settings 260. For example, a user can manually set a bandwidth cap representing the maximal data transfer speed to use for backup or migration operations in order to leave more bandwidth free for other operations.

In addition, the primary source controller 115 includes data transfer engine 120, which can be implemented as a piece of hardware or as a software component stored in a non-transitory machine-readable medium and executed on one or more processors, such as CPU 205. Data transfer engine 120 may be composed of several subcomponents used in adaptive data transfers with limited resources, namely performance monitor 220, backup scheduler 225, and stream management module 125, each of which can also be implemented in hardware or as software components stored in a non-transitory machine-readable medium and executed on one or more processors.

Performance monitor 220 keeps track of various limited resources available to the primary source controller 115. In some aspects, these limited resources are the CPU load 230, memory usage 235, and bandwidth usage 240. These values can be polled directly from the hardware components themselves or reported to another component such as a motherboard from which performance monitor 220 retrieves the resource data. Performance monitor 220 can structure and format these values into performance metrics 245 and provide them to stream management module 125 for use in adapting data transfers given the limited resources.

Backup scheduler 225 controls when backup streams 170 are initiated from the primary source system 110 to one of the secondary backup systems in accordance with user settings 260. For example, a user may schedule the primary source system 110 to backup data at a specific time every morning (e.g., 3 am) and save this schedule as a user setting 260. Since primary source system 110 can be associated with many data volumes and multiple users, there can be numerous backup schedules managed by the backup scheduler 225. In one aspect, backup operations are deemed more important than migration operations, and therefore the stream management module 125 can use the schedules 250 produced by backup scheduler 225 to proportion the number of streams dedicated to different operations at specific times. For example, if the schedules 250 inform stream management module 125 that a backup operation is scheduled for 3 am, the stream management module 125 can reduce the number of data migration streams 175 prior to 3 am so that backup streams 170 are minimally affected by the ongoing lower-priority migration process.

In one aspect, stream management module 125 uses a combination of performance metrics 245 and schedules 250 to determine a number of data migration streams 175 at a given time. Based on fluctuations in these factors, stream management module 125 can make migration stream adjustments 255 to the primary source system 110 to either increase or decrease the number of streams dedicated to migration operations. In aspects where stream management module 125 is provided on an external host, performance metrics 245 and schedules 250 can be transmitted to the external host. The external host can then transmit migration stream adjustments 255 back to the primary source system 110.

METHODOLOGY

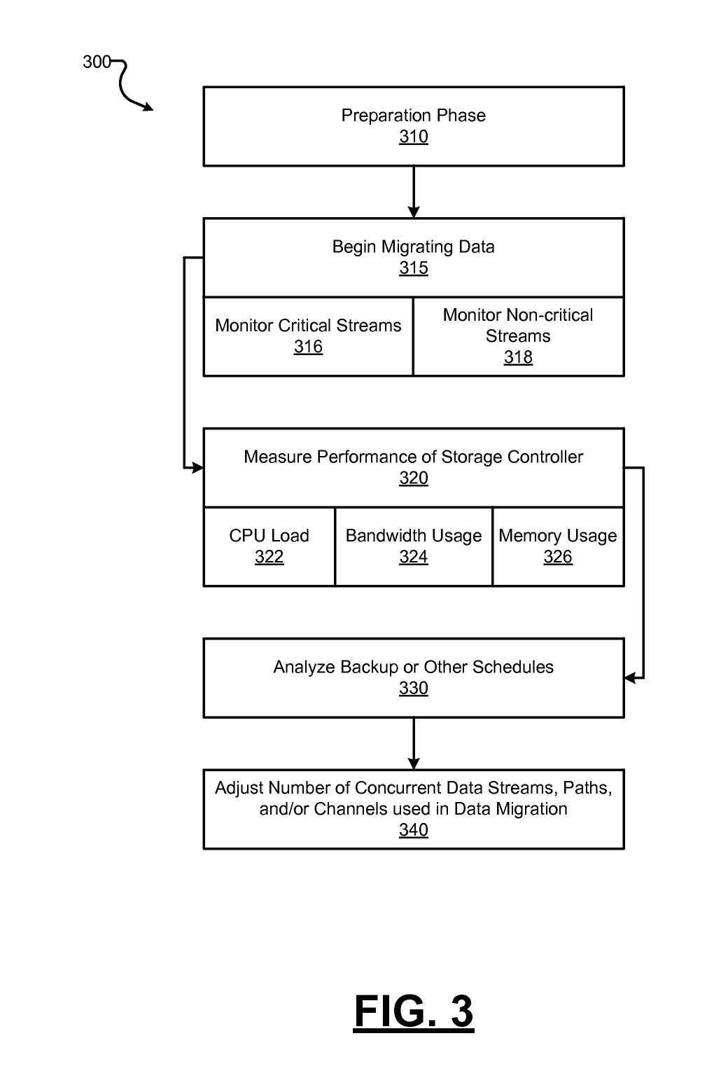

FIG. 3 illustrates an example method of adaptive data transfers with limited resources, in accordance with some aspects. While operations of the method 300 are described below as being performed by specific components, modules or systems of the data storage system 100, it will be appreciated that these operations need not necessarily be performed by the specific components identified, and could be performed by a variety of components and modules, potentially distributed over a number of machines. Accordingly, references may be made to elements of data storage system 100 for the purpose of illustrating suitable components or elements for performing a step or sub step being described. Alternatively, at least certain ones of the variety of components and modules described in data storage system 100 can be arranged within a single hardware, software, or firmware component. It will also be appreciated that some of the steps of this method may be performed in parallel or in a different order than illustrated.

With reference to an example of FIG. 1, the primary source controller 115 prepares primary source system 110 volumes 106 for the data migration process, through for example, a data storage system 100 as described with FIG. 1 (310). In some aspects, information about the source system (either primary or secondary) and volumes 160 is first collected. Next, information about the relationships between the volumes 160 and their respective source system is collected. For example, if the secondary source system 130 is being migrated, the preparation phase includes collecting information about the relationship between the secondary source system 130 and its volumes 160.

Next, the source system collects and adds cluster, server virtual machine, and aggregate information. IP addresses used by the source system are identified in the virtual machine, and new IP addresses are specified to be configured on the virtual machine. Finally, data copy schedules for baseline and incremental transfers are created.

After the systems and volumes are prepared for migration, the primary source system 110 begins migrating data (315). In one aspect, volumes 160 on the primary destination system 140 are set to read-only access, and a transition peer relationship is created between the data transfer engine 120 and the volumes 160 on the primary source system. In some aspects, volumes 160 are associated with a SVM or virtual server, and the peer relationship is created between the SVM and data transfer engine 120. Next, a migration relationship can be established between the primary source controller 115 and the primary destination controller 145. Once established, data from volumes 160 on the primary source system 110 can begin the process of migrating data to the primary destination system 140.

Depending on the number of volumes being migrated, the migration process may take hours or days. During this process, the stream management module 125 of the data transfer engine 120 can monitor data streams such as client streams 165, backup streams 170, 171, and data migration streams 175 that are incoming or outgoing from the primary source system 110. In some aspects, client streams 165 represent client accesses to the primary source system 110, and clients 105 may access data in the data storage system 100 through other channels. Stream management module 125 can designate these streams as either critical or non-critical and prioritize their operations accordingly. In some aspects, monitored critical streams include client streams 165 and backup streams 170, 171 (316). Since the data migration process can be expected to take significant time and a failure to back up data in a timely fashion could cause a loss of data in the event of a disaster, migration streams 175 may be deemed non-critical in comparison (318). However, in one aspect, migration streams 175 can be considered more critical than other streams during the cutover phase of the migration process when data relationships, logical interfaces (e.g., Internet Protocol addresses), and client access is switched over from the migration source to destination system.

While the migration process is ongoing, performance monitor 220 can monitor various limited resources of the storage controller in order to calculate performance metrics 245 (320). In one aspect, performance monitor receives CPU load data 230 from one or more CPUs 205 representing the current utilization percentage of the CPUs (322). Depending on how heavy the load is at a given time, the stream management module 125 can increase, decrease, or halt all migration streams 175. For example, if the CPU load 230 is greater than 95% of utilization, stream management module 125 may temporarily haft all migration streams 175 so that performance of more critical operations is not adversely affected by data migration. If CPU load 230 falls below 95%, stream management module 125 can resume migration streams 175, and if CPU load 230 falls even further, for example below 75%, more migration streams 175 can be employed to speed up the data migration process.

In some aspects, the memory usage 235 of memory 210 is monitored by the performance monitor 220 in order to determine the number of available streams the primary source controller 115 can manage simultaneously (324). In one aspect, a baseline number of available streams can be set by a user such as a server administrator of primary source system 110. Stream management module 125 can increase or decrease the available number of streams from this baseline number based on performance metrics calculated from the memory usage 235. For example, if 20 concurrent transfers are only using 50% of the memory 210, stream management module 125 can increase the number of migration streams 175 up to a safe level of memory usage 235.

Furthermore, performance monitor 220 can keep track of bandwidth usage 240 of the network interface devices 215. A user initiating the migration process can choose how much bandwidth to dedicate to migration streams 175, and stream management module 125 can increase or decrease the number of migration streams 175 to keep bandwidth usage 240 under the desired user settings 260 (326).

In addition to using performance metrics 245 of limited resources available to the primary source controller 115, the stream management module 125 can use data replication schedules 250 and other time-related information to make migration stream adjustments 255 (330). For example, if data replication backups are scheduled to begin at 3 am, stream management module 125 can reduce the number of migration streams 175 prior to 3 am so that the backup operations are minimally affected by the migration process. After the backups are completed, stream management module 125 can then resume the previous number of migration streams 175 that were paused during the backup. In some aspects, the time of day can also be used as part of schedules 250. For example, data transfer engine 120 may use half of all available streams for migration during the day but increase that number to 80% at night when fewer client accesses occur.

Finally, the stream management module 125 can use performance metrics 245 and schedules 250 to adjust the number of concurrent data streams used in data migration (340). In some examples, alternate mechanisms available to copy or move data beyond data streams can also be adjusted based on the analysis, such as data paths and data channels. In some aspects, when the performance metrics 245 are above a threshold set by a user (e.g., a server administrator), stream management module increases the number of migration streams 175. When the performance metrics 245 dip below a threshold, stream management module 125 can reduce the number of migration streams 175. In addition, stream management module 125 can make migration stream adjustments 255 based on schedules 250, pausing migration streams 175 during scheduled backup operations or times of heavy client usage and adding migration streams 175 once backups are completed or during times of low client usage. In some aspects, these thresholds can be adjusted by primary source controller 115 based on historical data gathered from performance metrics 245.

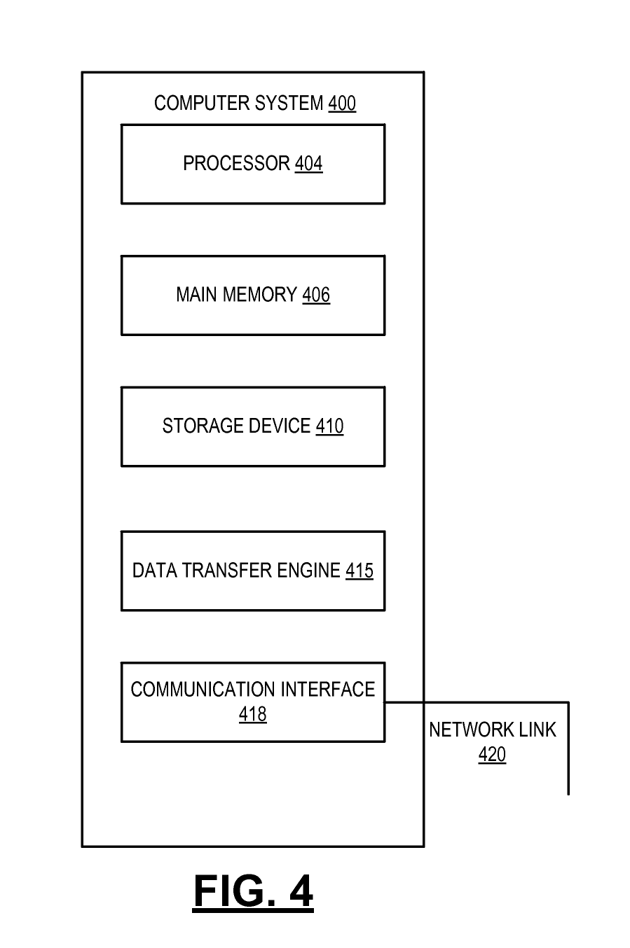

FIG. 4 is a block diagram that illustrates a computer system upon which embodiments described herein may be implemented. For example, in the context of FIG. 1, primary source system 110, secondary source system 130, primary destination system 140, and/or secondary destination system 150 may be implemented using one or more servers such as described by FIG. 4.

In an embodiment, computer system 400 includes processor 404, memory 406 (including non-transitory memory), storage device 410, data transfer engine 415, and communication interface 418. Computer system 400 includes at least one processor 404 for processing information. Computer system 400 also includes the main memory 406, such as a random access memory (RAM) or other dynamic storage device, for storing information and instructions to be executed by processor 404. Main memory 406 also may be used for storing temporary variables or other intermediate information during execution of instructions to be executed by processor 404. Computer system 400 may also include a read only memory (ROM) or other static storage device for storing static information and instructions for processor 404. The storage device 410, such as a magnetic disk or optical disk, is provided for storing information and instructions. The communication interface 418 may enable the computer system 400 to communicate with one or more networks through use of the network link 420 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks). Data transfer engine 415 is configured to transition the data stored on volumes from a source architecture to a destination architecture.

Embodiments described herein are related to the use of computer system 400 for implementing the techniques described herein. According to one embodiment, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method of data migration, the method being implemented by one or more processors and comprising:
migrating data from a first set of storage volumes to a second set of storage volumes, wherein migrating data uses a number of concurrent data streams managed by a storage controller;
measuring performance of the storage controller during data migration; and
adjusting the number of concurrent data streams used for migrating data based on the measured performance.

2. The method of claim 1, wherein the first set of storage volumes is associated with a first architecture, and the second set of storage volumes is associated with a second architecture that is different from the first architecture.

3. The method of claim 1, wherein measuring performance of the storage controller includes measuring CPU load, memory usage, network bandwidth usage, number of critical and non-critical data streams in use, and number of available data streams.

4. The method of claim 1, wherein the number of concurrent data streams used for migrating data is increased when the performance of the storage controller is above a first programmed threshold, and wherein the number of concurrent data streams used for migrating data is decreased when the performance of the storage controller is below a second programmed threshold.

5. The method of claim 4, wherein the first and second programmed thresholds are set by an individual with access to the storage controller.

6. The method of claim 1, further comprising:
analyzing a schedule of data streams determined to be more critical than the number of concurrent data streams migrating data; and
reducing the number of concurrent data streams migrating data during times corresponding to the schedule.

7. The method of claim 6, wherein the data streams determined to be more critical than the number of concurrent data streams migrating data are streams that backup data from the first set of storage volumes.

8. A data migration system comprising:
a memory resource to store instructions;
one or more processors using the instructions stored in the memory resource to:
migrate data from a first set of storage volumes to a second set of storage volumes, wherein migrating data uses a number of concurrent data streams managed by a storage controller;
measure performance of the storage controller during data migration; and
adjust the number of concurrent data streams used for migrating data based on the measured performance.

9. The system of claim 8, wherein the first set of storage volumes is associated with a first architecture, and the second set of storage volumes is associated with a second architecture that is different from the first architecture.

10. The system of claim 8, wherein measuring performance of the storage controller includes measuring CPU load, memory usage, network bandwidth usage, number of critical and non-critical data streams in use, and number of available data streams.

11. The system of claim 8, wherein the number of concurrent data streams used for migrating data is increased when the performance of the storage controller is above a first programmed threshold, and wherein the number of concurrent data streams used for migrating data is decreased when the performance of the storage controller is below a second programmed threshold.

12. The system of claim 11, wherein the first and second programmed thresholds are set by an individual with access to the storage controller.

13. The system of claim 8, further comprising instructions to:
analyze a schedule of data streams determined to be more critical than the number of concurrent data streams migrating data; and
reduce the number of concurrent data streams migrating data during times corresponding to the schedule.

14. The system of claim 13, wherein the data streams determined to be more critical than the number of concurrent data streams migrating data are streams that backup data from the first set of storage volumes.

15. A non-transitory computer-readable medium for implementing data migration, the non-transitory computer-readable medium storing instructions that, when executed by one or more processors, cause the one or more processors to perform operations that include:
migrating data from a first set of storage volumes to a second set of storage volumes, wherein migrating data uses a number of concurrent data streams managed by a storage controller;
measuring performance of the storage controller during data migration; and
adjusting the number of concurrent data streams used for migrating data based on the measured performance.

16. The non-transitory computer-readable medium of claim 15, wherein the first set of storage volumes is associated with a first architecture, and the second set of storage volumes is associated with a second architecture that is different from the first architecture.

17. The non-transitory computer-readable medium of claim 15, wherein measuring performance of the storage controller includes measuring CPU load, memory usage, network bandwidth usage, number of critical and non-critical data streams in use, and number of available data streams.

18. The non-transitory computer-readable medium of claim 15, wherein the number of concurrent data streams used for migrating data is increased when the performance of the storage controller is above a first programmed threshold, and wherein the number of concurrent data streams used for migrating data is decreased when the performance of the storage controller is below a second programmed threshold.

19. The non-transitory computer-readable medium of claim 18, wherein the first and second programmed thresholds are set by an individual with access to the storage controller.

20. The non-transitory computer-readable medium of claim 15, further comprising:
analyzing a schedule of data streams determined to be more critical than the number of concurrent data streams migrating data; and
reducing the number of concurrent data streams migrating data during times corresponding to the schedule.
